(19) United States
(12) Patent Application Publication
(10) Pub. No.: US 2004/0135902 A1
(43) Pub. Date: Jul. 15, 2004

(54) Image association process

(75) Inventor: Craig A. Steensma, Chicago, IL (US)

Correspondence Address: Brinks Hofer Gilson & Lione, P.O. Box 10395, Chicago, IL, 60610, US

(73) Assignee: Eventshots.com Incorporated

(21) Appl. No.: 10/657,974

(22) Filed: Sep. 8, 2003

Related U.S. Application Data
(60) Provisional application No. 60/439,384, filed on Jan. 9, 2003.

(51) Int. Cl. H04N 5/262

(52) U.S. Cl. 348/231.99; 348/231.2

(57) ABSTRACT

An image and data association system automatically associates a digital image with data identifying a person whose image is taken. A digital camera is used to take an image of an attendee at a large promotional event attended by hundreds or thousands of persons. When the image is taken, an operator provides a unique identifier, such as a barcode, an RFID tag, or an OCR tag to the person whose image is taken. The unique identifier is then scanned into the computer, and the computer automatically associates the unique identifier with the image. The process may also be used to add promotional items to the image before it is retrieved by the person whose image was taken.

This application claims the benefit of the filing date under 35 U.S.C. § 119(e) of Provisional U.S. Patent Application Serial No. 60/439,384, filed on Jan. 9, 2003, which is hereby incorporated by reference in its entirety.

### BACKGROUND

The invention relates to digital images and a method for storage and retrieval of digital images. An image or photograph of a person attending an event is useful in making attendance at the event memorable. An image that is also a souvenir may create a favorable impression for an advertiser that provides the image to a customer or potential customer. For an advertiser or sponsor, an “event” may be any meeting or gathering having a large number of customers or potential customers. Thus, an event may be a concert, an auto race, a promotional tour, or a trade show, such as an auto show or a convention of engineers or trade persons, and the like. An event may be a large sporting event, such as a major league baseball or football game, or a smaller sporting event, such as a 5K or 10K run for a charity. An event need not involve thousands of attendees, but instead may focus on a smaller event, such as a graduation, a special outing to a ski resort or a theme park, a wedding, a vacation on a cruise ship, or a business function.

These events have in common the attendance of a large number of people, many with at least a few moments of time that can be spared to have a picture taken. An advertiser or marketer of consumer products may wish to provide attendees with a picture-souvenir that also serves as a reminder of the event or the trip taken to attend the event. If the person enjoys the event, the picture-souvenir may help to associate the event with a favorable impression of the advertiser or marketer who supplied the picture-souvenir. Of course, organizations besides consumer-product marketers may also wish to use such images to increase their exposure and visibility, such as durable-goods manufacturers, automotive manufacturers, service-providers, and others.

Problems arise, however, in trying to provide such a personalized souvenir to each of a large number of people. Thus, providing an image on the spot may be impractical, since developing or printing hundreds or thousands of images may be very costly, or very time-consuming, or both. One solution to these problems has been the creation and storage of a digital image for later retrieval by the consumer, preferably through a computer using the Internet or other network. There are problems with later retrieval, however. Each image must be associated with the person whose image is taken, and often the association may be broken when an image is not taken, a person is not associated with an image, or the wrong person is associated the image.

Thus, while an advertiser or marketer has an opportunity to create a favorable impression by providing an image with pleasant associations, there are obstacles to providing the correct image to the correct person. There may also be negative associations formed if the process does not work correctly. The present invention is aimed at correcting these deficiencies in the prior art.

### BRIEF SUMMARY

This invention provides a method for automatically associating a digital image with data indicative of a person. The method comprises creating a digital image, transferring the digital image to a first computer, and automatically associating data indicative of at least one person with the image. The method also includes saving the digital image and the data indicative of the person.

Another aspect of the invention uses a computer program comprising program instructions for causing a computer to perform a process of creating a digital image, transferring the digital image to a first computer, automatically associating data indicative of at least one person with the image, and saving the digital image and the data indicative of the at least one person.

The invention also provides an image and data association system that associates a digital image with data indicative of a person. The system comprises a first computer, a digital camera operably connected to the first computer, and a detector operably connected to the first computer. There is also a computer program accessible to the computer for automatically associating the digital image taken by the camera with data indicative of the person. These and many other aspects of the invention will be made clear by the following drawings and descriptions.

### BRIEF DESCRIPTION OF THE DRAWINGS

FIG. 1 is schematic diagram of a first system embodiment of the present invention;

FIG. 2 is a schematic diagram of a second embodiment;

FIG. 3 is a front view of a computer useful in associating images with persons;

FIG. 4 is a barcode scanner for associating a person with an image;

FIG. 5 depicts two RF antenna and a card scanner useful for associating a person with an image;

FIG. 6 is an isometric view of a signature pad;

FIG. 7 is a schematic view of computer storage of images and data;

FIGS. 8a, 8b and 8c are schematic diagrams of data files;

FIG. 9 is a flowchart for a process for taking, associating, and saving an image and associated data;

FIG. 10 is a flowchart for a process for taking, associating and saving an image and associated data;

FIG. 11 is a flowchart for a process for validating and adjusting a digital camera;

FIG. 12 is a flowchart for a process for associating an image and gathering information from the person whose image was taken;

FIG. 13 is a flowchart for a process for uploading image and data files to a second computer;

FIG. 14 is a flowchart for a process for taking metrics in real time as images are taken;

FIG. 15 is a flowchart for a process for uploading files to a second computer through the Internet and processing the files;

FIG. 16 is a flowchart for a process for determining and validating a unique file number;

FIG. 17 is a flowchart for a process for validating the status of the digital camera;

FIG. 18 is a flowchart for a process for validating a unique identifier for a person whose image is taken.

FIG. 19 is a flowchart for a process for validating an Internet connection between a first computer and a second computer;

FIG. 20 is a flowchart for a process for gathering additional data from the person whose image is taken, and for providing marketing and promotional items to the person.

FIG. 21 is a flowchart for options to transmitting the image after the image is recorded; and

FIG. 22 is a flowchart for additional use of identification of the person after an image has been recorded.

### DETAILED DESCRIPTION OF THE DRAWINGS AND THE PRESENTLY PREFERRED EMBODIMENTS

The image and data association system may be used to quickly and automatically associate a digital image with data indicative of the person whose image is taken, or other data. Using the system, it is possible to take individual images of hundreds or thousand of persons at an event, quickly and automatically associate a unique identifier associated with each person with the image of the person, and present the person with a card or token that embodies the unique identifier. The person may then retrieve the image later. The person may retrieve the image from the Internet or other network at a convenient time and place.

The system includes a digital camera for taking an image and a computer for storing the image. Other equipment useful in associating the image with data indicative of the person whose image is taken may include a barcode scanner. Barcodes are not the only unique identifier that may indicative of the person whose image is taken, and any convenient system may be used, including a radio frequency identification (RFID) system, a magnetic card system, a biometric system, such as voice recognition, or an optical scanning system. In practicing the invention, it is convenient to have a sufficient quantity of unique identifiers available and ready to distribute to persons whose image is taken. For example, a quantity of tickets or cards with a barcode that includes a human-readable portion may be prepared in advance of the event at which images will be taken. The ticket is preferably human-readable so that each person may later read and enter the unique identifier in order to download the stored image.

An operator takes a digital image of the person. In order to save the digital image file, the operator then takes one of the barcode tickets and scans the barcode into the computer with a barcode scanner. The computer automatically associates a unique barcode identifier with the digital image file and saves the image. Information associating the image with the barcode identifier is preferably stored in a database file. The digital image file and the database file are then uploaded to a second computer, preferably via the Internet, for later retrieval by the person whose image was taken. The second computer saves the image files and updates its database files with information that associates an image file with each unique identifier. The person whose image is taken may access the second computer at his or her convenience. Using the ticket with a human-readable version of the unique identifier, he or she may then access the stored image file. The image may then be downloaded or electronically mailed to others.

FIG. 1 depicts an image and data association system 10 having a digital camera 12 interfaced with a mobile, lightweight computer 14. The mobile computer 14 is preferably a pen notebook, of which one example is a Fujitsu Stylistic LTP600, marketed by Fujitsu PC Corporation, Santa Clara, Calif. A barcode reader 18 is also connected to the computer. The computer 14 preferably has a processor 20 including memory and an input/output capability. A computer program for accomplishing the processes that are described below preferably resides in at least one memory of the computer 14 or processor 20. The computer preferably has a Windows® operating system. The computer preferably has a screen 22, which may be a touch screen, for viewing by a user. The computer also desirably includes a power supply 24, a modem 26, and an antenna 27. The modem and antenna are used to communicate data through the Internet or other network to a second computer 29, such as an Internet server for storing files from mobile, lightweight computer 14. The antenna may be replaced by a wire line or other connection to second computer 29. The computer preferably has at least one interface card 28 for accommodating peripherals such as barcode reader 18.

It will be understood that the invention is not limited to the illustration in FIG. 1, but also may have other configurations with equipment equivalent to the components described above, and may have configurations with fewer or with additional components. For instance, a small lightweight mobile computer is preferred, but a desktop computer or a laptop computer will also work in this application, albeit with less mobility for the user. A very small computer, with memory sufficient for storing the software and a number of images, may also be used. Thus, a personal digital assistant (PDA), such as a Palm Pilot, may be used rather than a larger computer. The computer may be integrated with the camera in a single, very small housing for further mobility and ease of use.

While a digital camera taking still photos is a preferred embodiment, a digital movie camera, such as a camcorder, may also be used to record and store images. Sound may also be stored as part of a digital movie or still photo. While a barcode scanner that scans barcodes is a preferred embodiment, other embodiments may use other detectors, such as an optical character recognition (OCR) reader that recognizes OCR data, or an RFID antenna that reads RFID tags, or a card reader that reads magnetic strips on cards swiped through the reader. Optical character recognition is a method of analyzing scanned images, and reconstructing alphanumeric information from the images. Each of these systems is used to supply a unique identifier to each person whose image is taken.

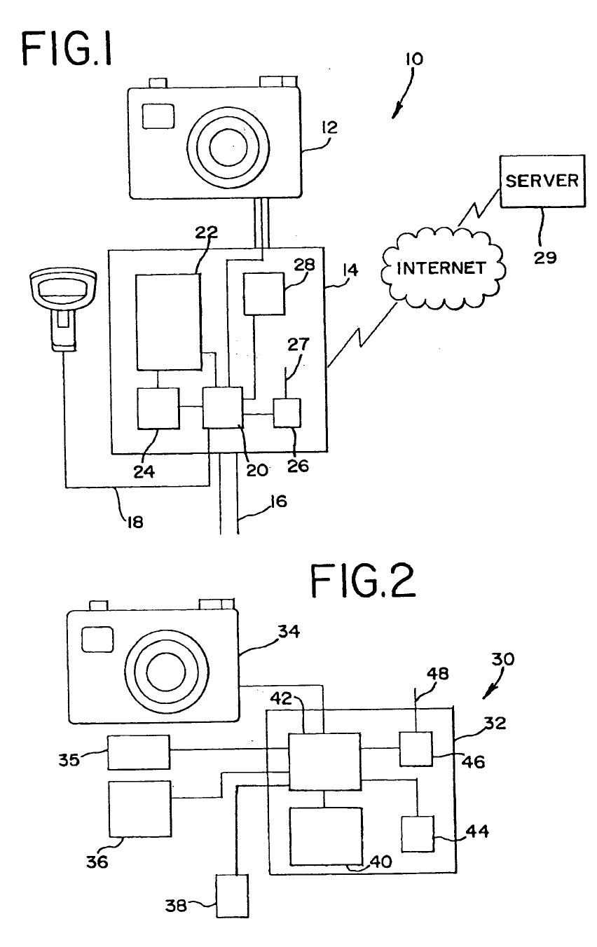

FIG. 2 is another image and data association system 30 having a computer 32, a digital camera 34, a signature pad 35, a detector 36, and a power supply 38. The system includes a processor 42 with memory and a touch screen 40, and at least one interface card 44. The system also includes a modem 46 and an antenna 48 for accessing the Internet and transferring data to another computer.

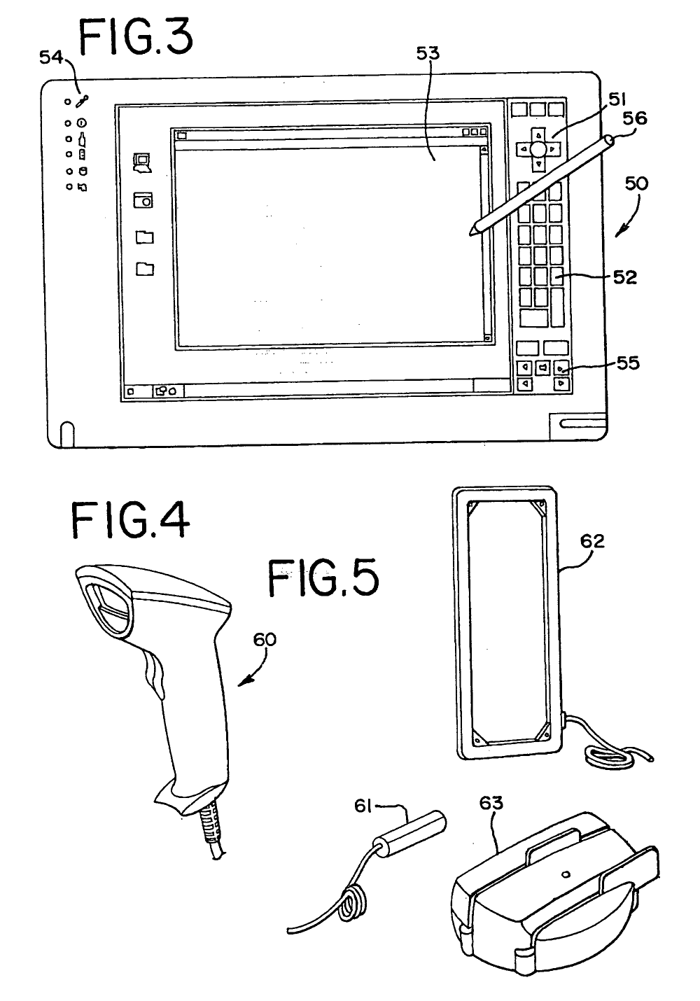

The mobile, lightweight computer is depicted in FIG. 3, although other computers may be used. The computer 50 preferably weighs less than three pounds and has a long-lasting battery. The computer has a touch pad 51 for maneuvering an indicator on the viewing screen 53, and also has status indicators or lights 54. Viewing screen 53 may also comprise a writing pad or a touch screen. The user may also operate the computer by using a stylus 56 to access a keypad 52 and function buttons 55. A typical barcode scanner 60 is depicted in FIG. 4. Barcode scanners are available from Socket Communications, Inc., of Newark, Calif., and others. A barcode scanner or other detector may communicate with computer 50 through a universal serial bus (USB) port.

Other detectors are depicted in FIG. 5. RF antennae 61 and 62 are available from Texas Instruments, Plano, Tex. In an RFID system, a user brings an RFID tag into close proximity to the RFID antenna so that the antenna, communicating with the computer, can “read” the tag. The computer then automatically associates the unique tag with the digital image taken. FIG. 5 also depicts a card reader 63 which may be used to “read” cards with a magnetic strip identifier or cards using an OCR identifier. Such readers are available from a number of suppliers, such as Aurora Bar Code Technologies, Ltd., Edmonton, Canada. These tags or cards preferably have human-readable alphanumeric characters for ease of use by the person in retrieving the image at a later time.

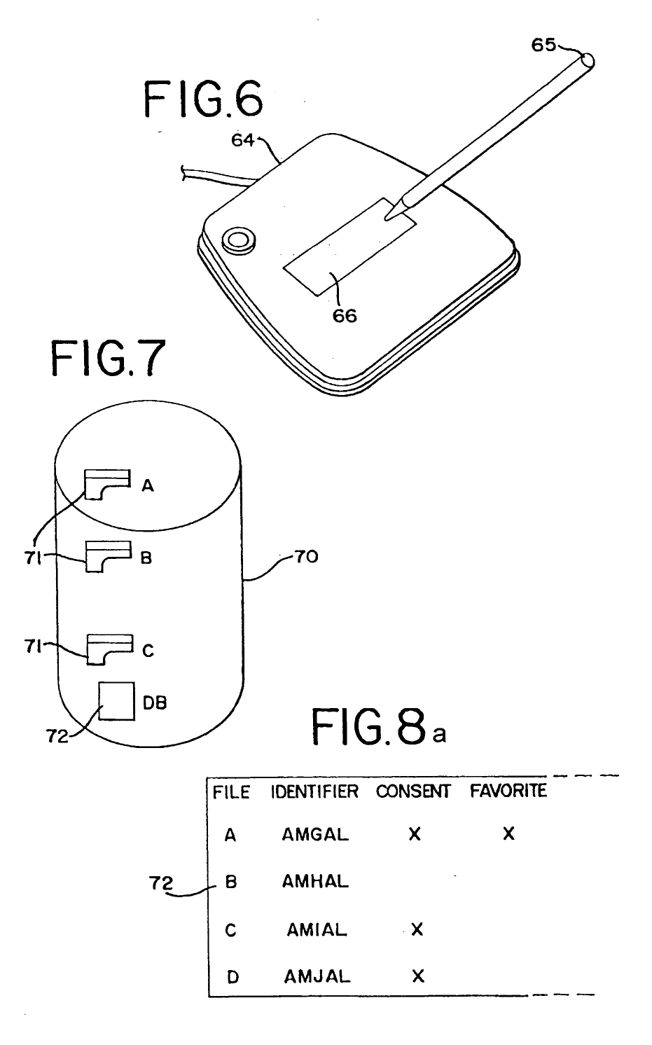

Another peripheral which may be used in conjunction with camera and computer is a signature pad. The signature pad may be used in a variety of ways. These include recording a signature for consent for taking the digital image, such as a release for marketing purposes or parental consent. The signature may be stored digitally and may be associated with the unique identifier and the image that have already been stored. The signature pad may also be used to annotate the image or to allow the person whose image is taken to write a comment. For instance, the person may digitally “write” a greeting that may appear on the image, if the person wishes later to send the retrieved image to others. A signature pad is depicted in FIG. 6. Signature pads are available from a number of suppliers, such as Interlink Electronics, Camarillo, Calif.

The digital images are stored in the first computer. As discussed below, each digital image is stored in a separate file. The association of the digital image file with the unique identifier supplied to the person whose image is taken is preserved in a database file. FIG. 7 depicts a computer memory 70 with image files 71 and a database file 72. The image files each store a single image in a file with a unique file name, such as A, B, or C in this embodiment. The image files are preferably in a JPEG format for a still image or in an MPEG format for a moving image format. Other formats may be used, such as GIF or EPS. Still images are preferred because they require less space in the memory (about 300 kb, which may be compressed to 80 or 90 kb), than moving images. Moving images may be short, from about 5 to about 10 seconds, as the sponsor desires. Longer or shorter times may also be used.

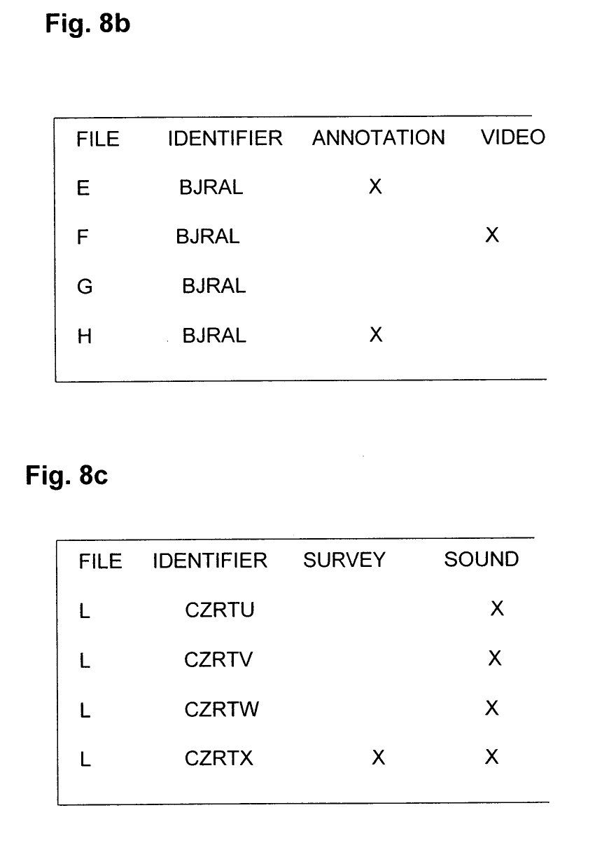

The database file 72 is depicted in FIG. 8a. The database file is updated each time an image is recorded. The database file, which may be in extensible markup language (XML) format or in Microsoft Access or other format, records data that allow the sponsor to accomplish a number of objectives. The primary objective of the database file is to associate the image with the identifier. In FIG. 8a, each row of the database, such as the first row, provides the association that is necessary for storage and retrieval of the correct image by the person whose image is taken. Thus, the first row in the database associates image file A with unique identifier AMGAC, which was provided to the person whose image was taken. In this embodiment, each column provides additional information that may be useful to the sponsor. Thus, database file 72 also has a column for noting whether consent for publicity was given, and a column for noting whether the image was “marked” by the user (photographer) as a “favorite.” Other columns, not shown, may also be used to indicate whether a greeting or annotation was made, and may provide the file name for retrieving the stored greeting or annotation. Other columns and associations may be made.

FIG. 8b is an example of a database file in which several photos, files E, F, G, and H have been stored and are associated with a signal identifier BJRAL. The system allows for storage and retrieval of multiple images for a single person with a single identifier. In this example, two of the images contain an annotation, and one of the images is a video image. FIGS. 8c is an example of a database file in which a single image file L has been stored and has also been associated with four different identifiers. In this example, the image has been recorded with sound, and the same image with the same sound is associated with four different persons. In this example, only one person completed the survey taken with the image was made.

In addition to providing the associations mentioned, the database file may be used to provide metrics of the digital images taken at the event. The database automatically keeps a count of the number of images, the number of persons giving consent, the number of images marked as “favorite,” and so on. By recording the time of each image, an elapsed time may also be recorded for taking each image, and a total elapsed time may be recorded for the entire event, or for portions of the event. As discussed below, the file may be used to record any features added to the photo, such as watermarks, logos, greetings, annotations, and the like. A watermark or logo may be any feature, background, situation, or image that the sponsor wishes to superimpose on the image. Thus, the image of the person may be superimposed onto a racecar, a human body, or other desirable image. This superimposition may take place in the first computer or may take place after the person's image is uploaded to the server, in order to conserve memory and to ensure faster transmission of the image to the server.

The database file may also be used later, when the person retrieves the image, to record metrics of consumer responses. These records may include the number of persons who did retrieve the image, the number of persons who responded to questions from the sponsor, and the number of persons to whom a special marketing or promotional offer was made.

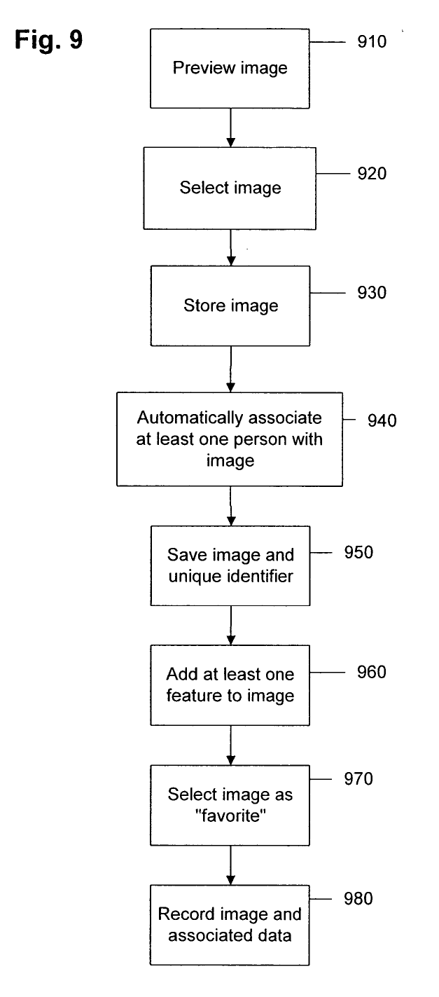

FIG. 9 is a flowchart for a method of automatically associating an image with data indicative of a person, or other data. A photographer may use 910 a “preview” mode of the camera, and ask the person whose image is being taken to change the pose. The photographer may also freeze the image, allowing the person to select 920 the desired pose. When this process is complete, the image is stored 930. The photographer or user then automatically associates the person with the image 940. More than one person may be associated with the image. This is accomplished by scanning a barcode into the computer. When the barcode is scanned, the computer automatically associates the barcode with the image, and saves the image in an MPEG file and saves 950 the association with the unique barcode identifier in a database file. If desired, a feature may be added 960 to the image. The feature may be a logo of the sponsor, a “watermark,” such as a background or foreground, an advertisement, a slogan, an Internet URL, a signature or greeting from the person, or other desired feature. The image may be marked 970 by the photographer or user or the sponsor as a “favorite,” for later retrieval of images that are especially pleasing. The image may be recorded 980 and a record made of the desired features associated with the image for electronic construction of the image at a later time.

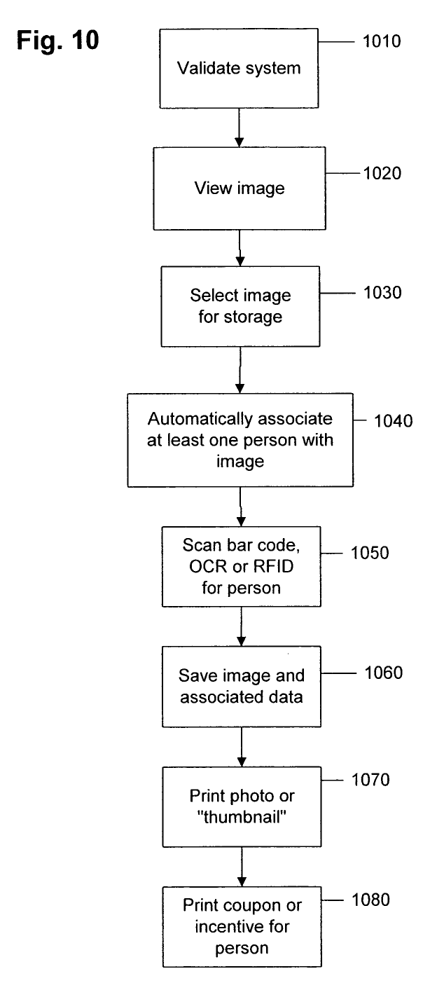

FIG. 10 is a flowchart for another method of associating an image with data identifying a person. The system for associating an image with a person is validated 1010. Validation consists primarily in assuring that each component of the system is turned on and is connected for the transmission or reception of data. Validation consists primarily in a “handshake,” which may be described as a connection-oriented protocol for exchanging control information between components to verify that one component is ready to receive data before sending it, and another component is ready to send the data. When the handshake is successful, the components have established a connection and are said to have been validated. After validation, the system is ready for operation.

The photographer or the person whose image is being taken may then view 1020 the image in “preview” mode before selecting 1030 an image for storage. The computer then automatically associates 1040 at least one person with the image. If there is more than one person in the image or photo, the association is accomplished by scanning 1050 a unique barcode for each person in the photo. Thus, if a group photo has five persons, the photographer takes the image, and then scans in one unique barcode at a time for each of the five persons. The computer associates each of the five barcodes with the most recent image. The association is preserved in the database file. Later, when each person in the image retrieves the image, it is available to him or her individually. If barcodes are not used, then the same procedures may be followed for an OCR process, an RFID process, or a magnetic card process. The image and associated data are saved 1060. In one embodiment, it may be desirable to print 1070 an image at the event for a person. If a larger size image, such as a 3×5 or 4×6 photograph is not practical, a small card with a “thumbnail” image may be printed instead. In addition to the photo or thumbnail photo, a coupon or incentive may be printed 1080 at the event and given to the person.

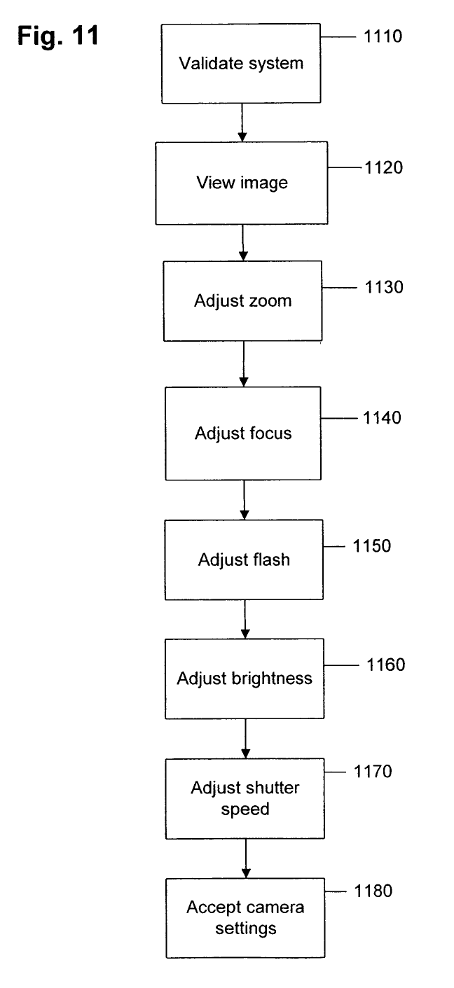

Attention may be paid to the photographic process as well. FIG. 11 depicts a flowchart for a method that may be used by the photographer or user to adjust the camera to improve the image taken. The camera may be completely integrated with the computer so that the following processes are accomplished with the computer. The camera and computer connection is validated 1110 and an image is viewed 1120 on a screen of the computer. The photographer may adjust the camera settings in order to take better images. The photographer may adjust 1130 the zoom, adjust 1140 the focus, adjust 1150 the flash setting, adjust 1160 the brightness, adjust 1170 the shutter speed, and make any other desired adjustments. Then photographer may then accept 1180 the settings and the camera is ready for taking images.

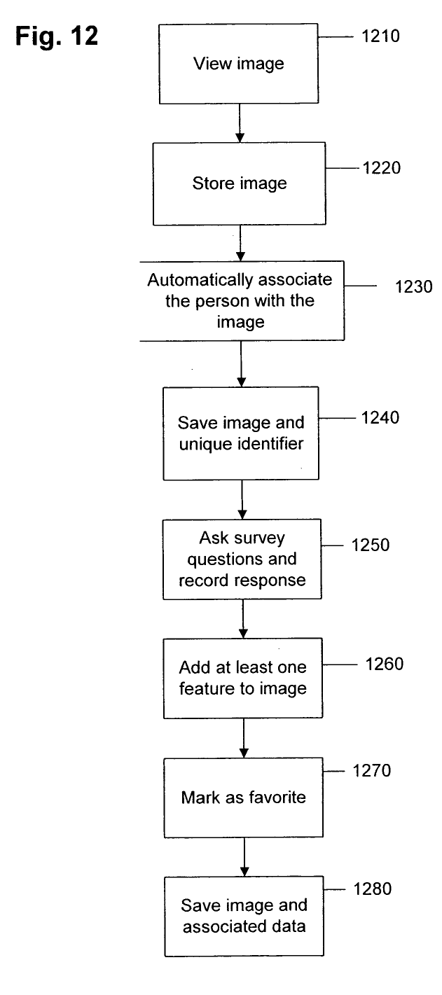

FIG. 12 is a flowchart for another method for using the event as a promotional tool for gathering information and communicating to potential customers. A person at an event is viewed 1210 in the camera and an image is stored 1220. The computer automatically associates 1230 the person with the image using one of the unique identification methods discussed above. The computer then saves 1240 the image and the association of the image with the unique identifier.

The sponsor may wish for the photographer to gather more information from the person or persons whose image is taken. For instance, the sponsor may ask 1250 survey questions about product consumption, such as, “Do you drink our brand of soft drink?”, or “Do you carry a certain credit card?” The photographer or user may then record the answers using the computer or using a peripheral device operably connected to the computer. The responses are preferably saved in the database file. The remainder of the process described above may then take place, such as adding 1260 at least one feature to the image, such as the sponsor's URL or a slogan or message from the sponsor. The image may be recorded 1270 as a “favorite,” if the photographer believes it to be exceptional in some manner. The image and the data associated with the image are then saved 1280.

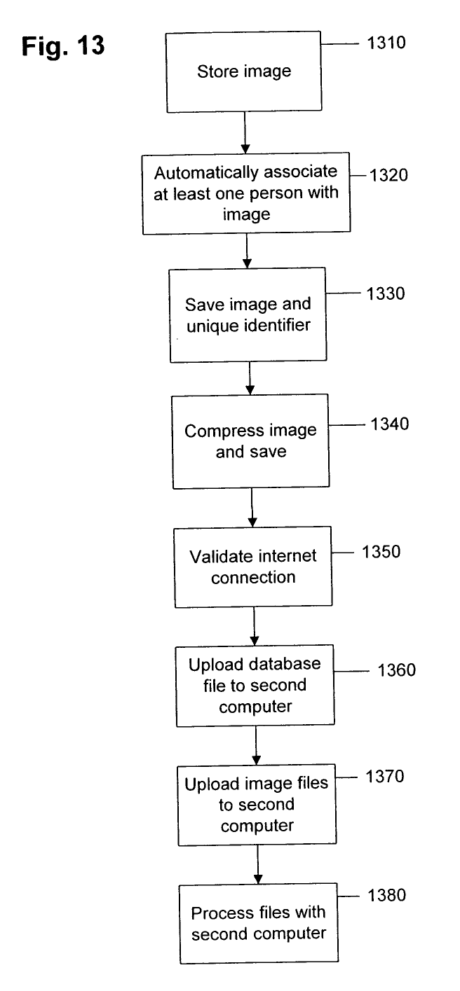

FIG. 13 is a flowchart for another method for automatically associating data identifying a person, or other data, with an image. As discussed above, the photographer or the user may take and store 1310 an image and automatically associate 1320 the image with at least one person. The image and unique identifier are then saved 1330. In order to conserve computer memory storage, and to ease the transfer of data to the server, the computer may use a data compression routine to compress and save 1340 the image before transfer. One program useful for compressing images is ImgX compression and imaging library software by Atalasoft, Inc., Westfield, Mass. Other compression routines may be used. The image may be uploaded to a second computer, such as an Internet server. To accomplish this transfer of data, the connection from the first computer through the modem to the Internet is validated 1350, as is the connection of the server to the Internet. The mobile computer then uploads 1360, 1370 both a database file and image files to the server or second computer. The server or second computer then processes 1380 those files. The database file may be used to update an existing database file in the second computer, and the image files may be saved and their locations noted.

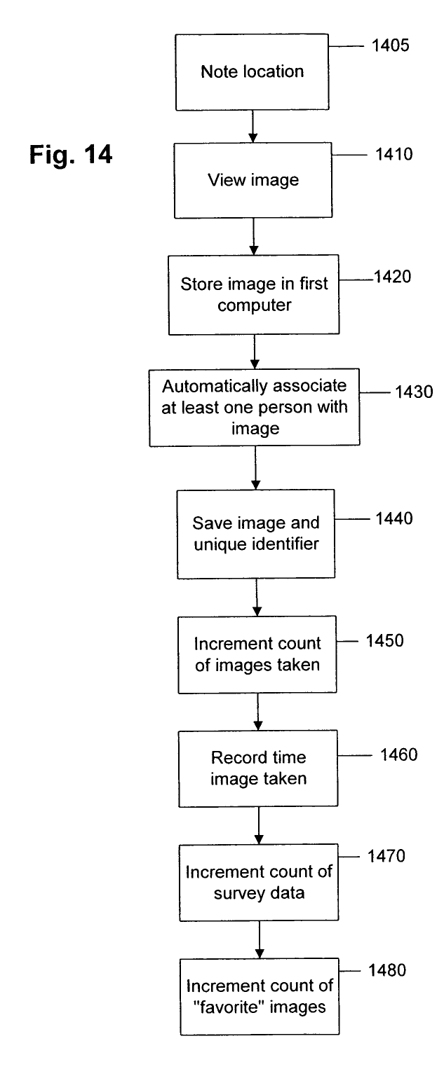

The process of taking images of hundreds or thousands of people at a large event, or even a smaller event, may be a very frenzied and hurried process as one or more photographers try to service many persons. The sponsor may desire metrics of the event, some quantitative measure of how many images have been taken, and the like. FIG. 14 is a flowchart for a method for recording such data automatically as images are taken and stored. The photographer may note 1405 the location at which the photo was taken, such as in front of a particular promotional background (e.g., vehicle, concourse, backdrop, etc.). The photographer poses the person and views 1410 the image on the screen. The photographer stores 1420 the image and automatically associates 1430 the image with at least one person in the manner already described. The image and the association are saved 1440. The database file at that point may increment 1450 a count of the number of images taken, and thus the database file keeps a running total of the number of images taken and at which locations at the event. The database file may also record 1460 the time the image was stored. This enables a user to later go back into the files and determine the quantity of picture taken for any given time period for any location. If the photographer asks questions of the persons, the count of answers or responses may be incremented 1470, and thus a running total may be kept on questions of interest to the sponsor. If the photographer is “marking” certain images as “favorites,” the count of favorite images may be incremented 1480 every time an image is so designated. These and other metrics may be automatically kept and updated in real time as the event proceeds.

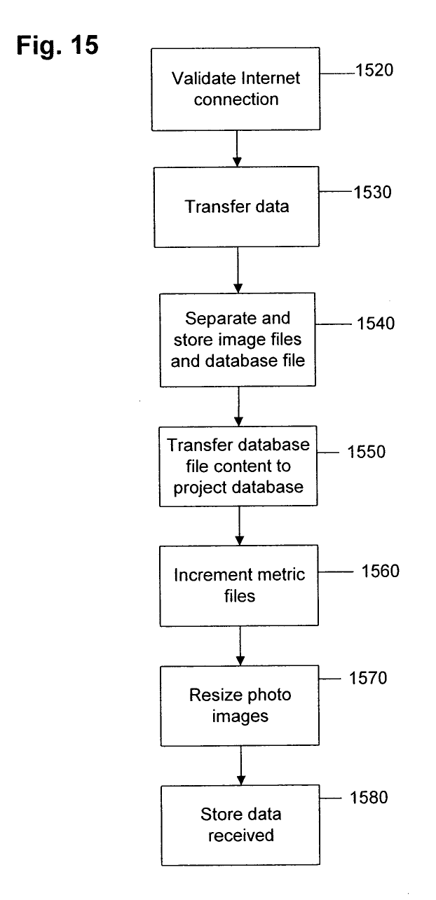

There may be continuing or intermittent communications between the mobile computer at the event and the second computer or server that stores the images and enables persons to retrieve the images. FIG. 15 is a flowchart for a method of enabling the computers to communicate and transfer the files between them. The mobile computer transferring the files validates 1520 its Internet connection to the server. Once the “handshake” is affirmed, the transfer 1530 of files and data may proceed. In the second computer or server, the files are separated 1540. Image files are stored with their unique file names, and the database file is used to update 1550 a database file in the server.

At a large event, there may be several cameras and mobile computers communicating with the same server. Each of the mobile computers transfers its files to the server. The files are distinguished because each file has a unique file name and is associated with a unique identifier for the person whose image was taken. The database file in the server is updated each time another mobile computer transfers its files and its accompanying database file. When the server database file is updated, it may also increment 1560 any metric files it keeps, such as the number of images taken, the number of favorite images, and so on. If the image files were compressed in the mobile computer before transfer, the server may also resize 1570 the images and perform other desired postprocessing on the images. For instance, the sponsor may add a feature to the photo at the server stage, rather than at the mobile computer stage. Finally, the data received from the mobile computer is stored 1580.

The image and data association system may include continuing or intermittent validation of the system. It is important that each image saved is associated with the person in the image. This is readily accomplished if each image has a unique file name, and the unique file name is then associated with the correct person. As noted above, other combinations of files are possible, such as when a group picture has more than one person. In this case, the unique file name for the group picture should be associated with as many identifiers as there are persons in the photo. It is also possible that one individual may have more than one image taken. The barcode card or other identifier for that individual will then correspond to more than one image; however, each image will have a unique file name. Thus, there may be a one-to-one correspondence between images and persons, or there may be other correspondences as described here. It is important that each person be able to retrieve the desired images, and this is only possible if the file names of the images are correctly associated with the identifiers supplied by the barcoding or other devices used.

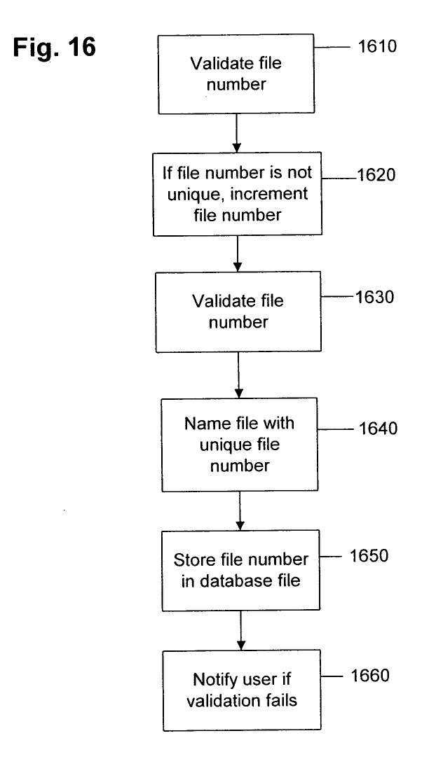

FIG. 16 is a flowchart of a method for insuring the correct correspondence between the image files and the data indicative of the persons whose images are taken. The file number about to be used for storing an image is validated 1610. A proposed file number for the image is compared to existing file numbers. If the file number is already present (and thus used), another file number is proposed, such as by incrementing 1620 the file number. If the file number is unique, it is then validated 1630 for use. The file is then named and stored 1640 with that number, and the file number is also stored 1650 in the database file. That is, the file number for the image is associated with the unique identifier from the barcode or other system used to identify the person whose image was taken. The computer may also notify 1660 the user or photographer if validation fails, such as by sounding an alarm, changing a status light, or otherwise displaying an error message on the screen of the mobile computer.

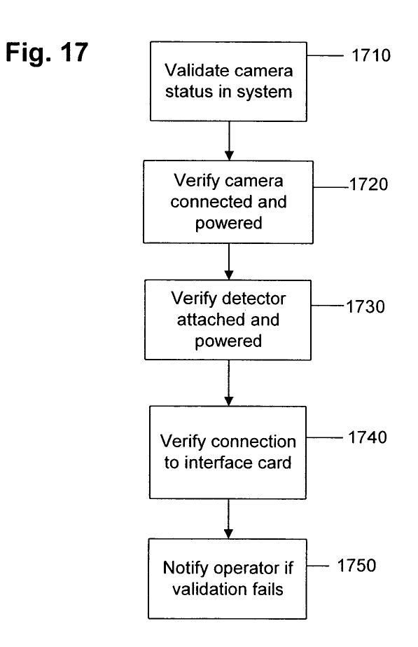

FIG. 17 is a flowchart for validating the components of the system. This validation is necessary for insuring that the system is working properly. The computer may first validate 1710 the camera, that is, verify that the camera is connected and is powered 1720. The computer may also validate the detector by verifying 1730 that the detector is attached and powered. As discussed above, a detector may be a barcode scanner, an RFID antenna, a card reader, or other device for inputting a unique identifier for the person whose image is taken. The computer may also validate 1740 the connection to one or more interface cards used in the computer, such as for the detector or the camera. The process may also include notification 1750 to the operator if validation fails. The notification may take place by any convenient means, such as by lighting an LED status light or displaying an error message on the screen of the computer.

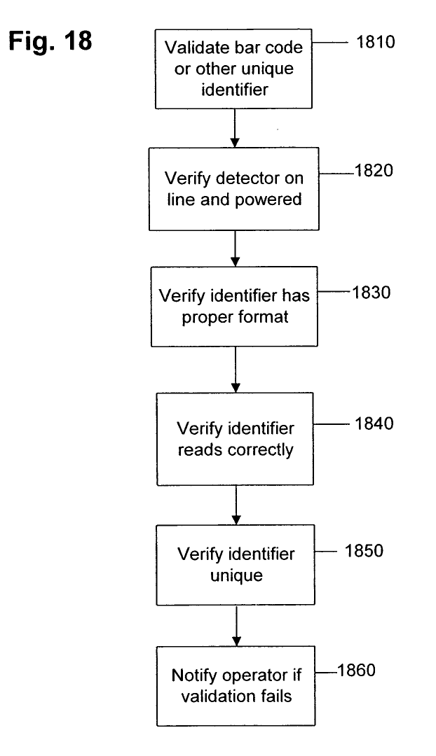

The image and data association system may also include more validation steps, as depicted in FIG. 18, to insure the association of the unique image file with the proper unique identifier given to the person whose image is taken. When the photographer or user scans the barcode into the computer, the computer validates 1810 the scanned barcode. The detector or scanner is validated 1820 as being present and is powered. The validation may than take place in several ways, such as to verify 1830 the proper number of characters or format, and to verify 1840 the integrity and readability of the characters. The validation step preferably also verifies 1850 that the barcode is unique. While in some embodiments, a single bar code may be associated with more than one image, one or more barcode images per identifier is also possible. If validation fails for any reason, the system may notify 1860 the operator. Notification may take place by sending an error message or other notification. The system may also simply refuse to proceed until another barcode card is tried.

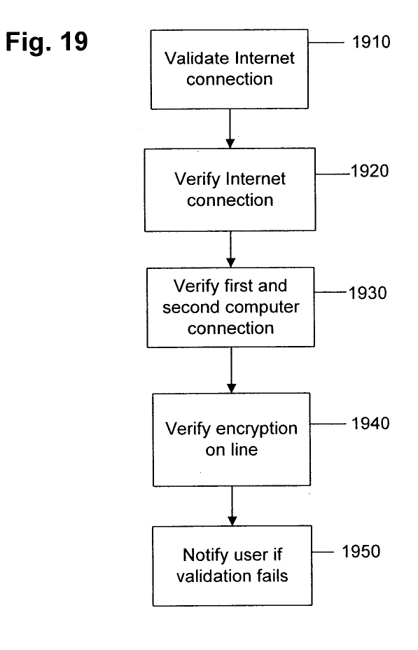

FIG. 19 is a flowchart for a method for validating the Internet or network connection for uploading the stored images and database files to the server. The Internet connection is validated 1910. The system may verify 1920 that the modem is present and powered and that the antenna is present. The system may then verify 1930 that the second computer or server is present and active. If encryption software is to be used, the system may verify 1940 that the encryption software is active and ready to proceed. If any of these connections or validations fail, the system cannot proceed, and the system may notify 1950 the operator or use of the failure.

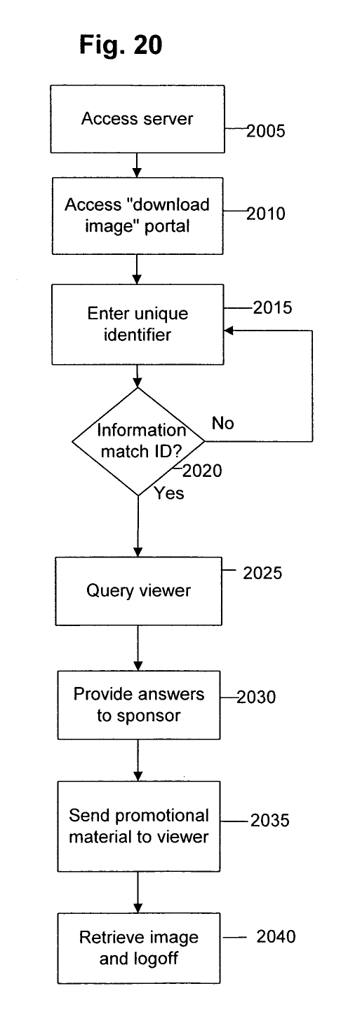

Information or responses from the consumer may also be gathered when the person retrieves the image, and there is more time to provide responses. FIG. 20 is a flowchart of a method for the person whose image is taken to retrieve the image. This process provides an opportunity for the sponsor to interact with the person. The person retrieving the image accesses the image through an Internet server provided by the sponsor. The person accesses 2005 the server and accesses 2010 the portal designated for downloading the stored image. The person then enters 2015 the human-readable version of the unique identifier that was supplied when the image was taken. The server matches 2020 the identifier to the stored image identifier, and if there is a match, proceeds 2025 to a survey. If there is no match, the server increments or tries another identifier.

Rather than immediately providing the image, the sponsor may wish to take the opportunity to query 2025 the person with a series of questions of interest to the sponsor. These questions may include questions concerning personal habits or consumption of consumer goods. They may also include questions about any intended purchases of durable goods or major purchases, such as “Do you intend to purchase a car within the next_months?” or “Do you use_brand toothpaste?” The consumer may provide 2030 answers to these questions. The sponsor may then respond by sending 2035 selective promotional or other material to persons meeting certain criteria desired by the sponsor. The sponsor may also include dynamic questioning, with the answer to a first question determining the next question to be asked. For example, if a person responds “yes,” to a question about the person's interest in some activity, the next question may concern that activity, while a “no” response may lead to a question in a different area. Of course, the question screens may use graphics or other features to pique the user's interest. At the end of the session, the person may retrieve 2040 the image and logoff.

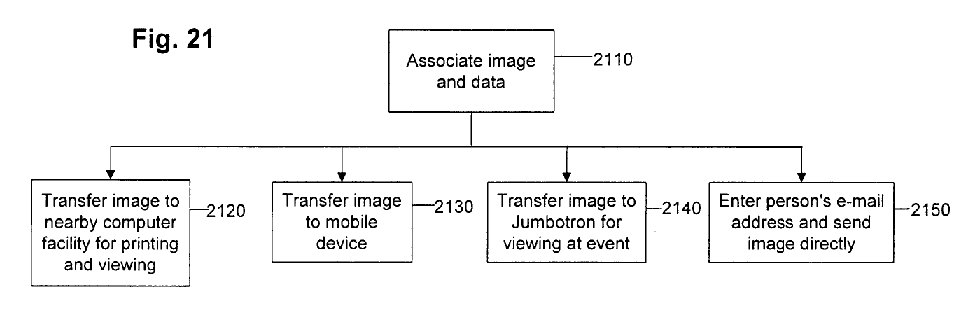

The stored image may also be used in other ways, as depicted in alternative uses in FIG. 21. After the image and the association are associated and stored 2110, the person may wish for the image to be used at the event. Thus, the sponsor may transfer 2120 the image to a nearby computer facility for printing and viewing by the person. The facility may be able to print a photo, or to further transfer the photo onto a souvenir, such as a T-shirt or a coffer mug. The person may alternatively request that the sponsor transfer the image to a mobile wireless device, such as a telephone able to accept the file, or to a hand-held wireless computer, such as a personal digital assistant (PDA). If the event is a sporting event, the sponsor may make arrangements to transfer 2140 the image to a large screen computer monitor, such as a Jumbotron on an athletic field. The person may also request the sponsor to enter the person's e-mail address and send the image 2150 to the person directly over the Internet.

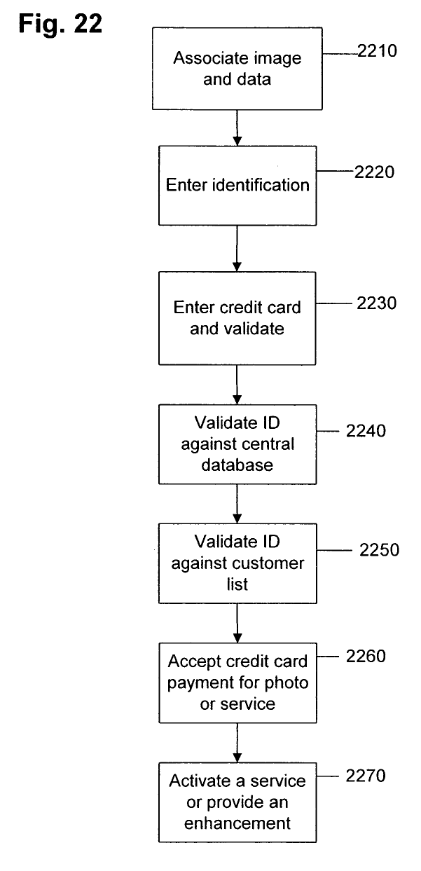

In addition to sending the image to other computers, a user may wish to use the image or the available computing power in other ways, as depicted in FIG. 22. As discussed above, the image is associated 2210 with identifier data and stored. The sponsor may also enter identification 2220 for the person whose image was taken, such as by entering the person's name, or a driver's license number, a credit card number, a debit card number, or a commercial account number. The sponsor may swipe a credit card from the person whose image has been taken through card reader. Information from the credit card may then be used to identify the person or to make a purchase. If the person is contemplating a purchase, the credit card or debit card may be entered and validated 2230 by the creditor. Alternatively, a person's identification may be validated 2240 against a central database, or may be validated 2250 against a sponsor's customer list.

In one example, if a sponsor is contemplating offering premiums for new customers, the sponsor may check the person's identity for creditworthiness. In another example, the sponsor may check the person's identity to determine whether the person is already a customer and thus should not receive a premium for new service; the sponsor may instead offer a service enhancement of some sort. The sponsor or another vendor may also use the person's identification and credit card to accept payment 2260 for printing the photo or for other merchandise or service provided at the event. The person may also choose, at the event, to activate a service 2270 or to purchase an enhancement for a service.

The systems and methods described above may have other configurations and arrangements. In one example with the barcode identifiers mentioned above, the photographer may have a large stack of pre-printed barcode cards or tickets ready, so that the photographer can scan a barcode card and hand it to the person. It is not necessary to preprint the cards, however, which may be generated and printed on the spot. However, printing may take time and requires a printer. Therefore, while it is preferable to have barcode cards or tickets preprinted, the method does not require preparation before the event. The same holds true for OCR cards, magnetic strip cards, IR tags, and so on. The process can also involve simply capturing the participants' e-mail address upon taking the photo, then e-mailing them the photo instantly or after the event.

A Windows® operating system may be used because it is ubiquitous. However, other operating systems will also work, such an Linux, UNIX, Apple McIntosh, or even DOS, and the like. Systems and processes using these operating systems may also be used in embodiments of the present invention.

The images discussed above may also be processed in a number of other ways, depending on the desires of the sponsor. For instance, the images may be encrypted during transmission, or even during storage, so that only the person with the barcode or other identifier may access and decode the file containing the image. Encrypted or not, many of the formats for wireless data exchange may be used for transferring the files from the computer at the event to the second computer. “Wi-Fi” or “wireless fidelity” formats according to IEEE 802.11 specification may be used. Validation during the processes described above is an important step. The image and the data indicative of a person may be associated and saved by double-validation, that is, validation by both components exchanging data, such as the camera and the first computer, or the detector and the first computer.

It is therefore intended that the foregoing detailed description be regarded as illustrative rather than limiting, and that it be understood that it is the following claims, including all equivalents, that are intended to define the spirit and scope of this invention.

What is claimed is:

1. A method for automatically associating a digital image with data indicative of a person, the method comprising:
creating the digital image;
transferring the digital image to a first computer;
automatically associating data indicative of at least one person with the image; and
saving the digital image and the data indicative of the person.

2. The method of claim 1, further comprising transferring the digital image to a second computer for later retrieval by the at least one person.

3. The method of claim 1, wherein the digital image created is selected from the group consisting of a still image, a motion picture image, and an image with sound.

4. The method of claim 1, further comprising e-mailing the digital image to the person.

5. The method of claim 1, further comprising adding at least one feature to the digital image, the feature selected from the group consisting of a watermark, a signature, a greeting, a phrase, a logo, an internet URL, and a background.

6. The method of claim 1, further comprising compressing the digital image.

7. The method of claim 1, wherein the step of saving the digital image is accomplished by validating a unique file name for the digital image.

8. The method of claim 1, wherein the step of saving the digital image is accomplished with a double-validation step.

9. The method of claim 1, wherein the step of automatically associating data indicative of at least one person with the image is accomplishing by creating or entering a unique identifier for the at least one person.

10. The method of claim 9, wherein the unique identifier is entered by one of scanning a barcode, scanning optical characters, reading a card, and scanning an RFID tag.

11. The method of claim 10, further comprising validating the barcode, information from the card, optical characters, or RFID tag.

12. The method of claim 2, wherein the step of transferring the digital image to a second computer is accomplished by transferring at least one digital image file and a database file.

13. The method of claim 13, wherein the step of transferring the digital image to a second computer is accomplished by a validation step.

14. The method of claim 1, wherein a plurality of digital images are created, transferred, automatically associated with data indicative of at least one person in the image, and saved with the data indicative of at least one person for each image, and further comprising recording information about the digital images taken.

15. The method of claim 14, wherein the information recorded is selected from the group consisting of an elapsed time for taking the digital images, whether an image is marked as “favorite,” a response to a consumer survey question, an indication whether information was provided by a person, an indication whether consent for the image was given, an indication whether parental consent was given, an indication whether an image file includes motion, an indication whether an image file includes sound, and an indication whether an image file includes an annotation.

16. The method of claim 14, further comprising counting and displaying a total for at least one category of information recorded.

17. The method of claim 1, wherein a plurality of digital images are associated with data indicative of a single person and saved with the data indicative of the person.

18. The method of claim 1, wherein a single image is associated with data indicative of at least two persons and is saved with data indicative of each person.

19. The method of claim 2, further comprising processing the data by the second computer.

20. The method of claim 2, further comprising processing the data by the second computer, wherein image files from the first computer are stored and locations of the image files are recorded, and database files containing data indicative of the at least one person from the first computer are stored separately from the image files.

21. The method of claim 20, wherein metric files are updated by the database files from the first computer.

22. The method of claim 20, wherein the metric files are selected from the group consisting of an image count, an elapsed time for taking the digital images, a count of whether an image is marked as “favorite,” a count of responses to a consumer survey question, a count of indications whether information was provided by a person, a count of indications whether consent for the image was given, a count of indications whether parental consent was given, a count of indications whether an image file includes motion, a count of indications whether an image file includes sound, and a count of indications whether an image file includes an annotation.

23. The method of claim 2, further comprising preparing at least one question for response by a person retrieving the digital image.

24. The method of claim 2, further comprising receiving a response from the person retrieving the digital image and providing sales or promotional information to the person in response to an answer to the at least one question.

25. A method for automatically associating a digital image with data indicative of a person, the method comprising:
creating a digital image;
transferring the digital image to a first computer;
scanning a unique identifier for a person into the first computer;
automatically associating the unique identifier with the digital image;
saving the digital image and the unique identifier; and
transferring the digital image to a second computer for later retrieval by the person.

26. The method of claim 25, wherein the step of scanning the unique identifier is accomplished by one of scanning a barcode, reading an OCR pattern, reading a magnetic data card, and scanning an RFID tag.

27. The method of claim 25, wherein at least one of the steps of creating the digital image, transferring the digital image to the first computer, scanning the unique identifier, saving the digital image, and transferring the digital image to the second computer, is accompanied by a validation process.

28. The method of claim 25, further comprising compressing the digital image before the step of transferring the digital image to the second computer.

29. The method of claim 25, further comprising recording information concerning a plurality of digital images, and counting and displaying a result for at least one category of information recorded.

30. The method of claim 29, wherein the information is selected from the group consisting of an image count, an elapsed time for taking the digital images, a count of whether an image is marked as “favorite,” a count of responses to a consumer survey question, a count of indications whether information was provided by a person, a count of indications whether consent for the image was given, a count of indications whether parental consent was given, a count of indications whether an image file includes motion, a count of indications whether an image file includes sound, and a count of indications whether an image file includes an annotation.

31. The method of claim 25, further comprising e-mailing the digital image to the person.

32. The method of claim 25, wherein the second computer stores the digital image and stores separately a database file containing information about the image.

33. The method of claim 25, further comprising adding at least one feature to the digital image, the feature selected from the group consisting of a watermark, a signature, a greeting, a phrase, a logo, an internet URL, and a background.

34. The method of claim 25, further comprising preparing at least one question for response by a person retrieving the digital image.

35. The method of claim 34, further comprising receiving a response from the person retrieving the digital image and providing sales or promotional information to the person in response to an answer to the at least one question.

36. A system for automatically associating a digital image with data indicative of a person, the system comprising:
a first computer;
a digital camera operably connected to the first computer;
a detector operably connected to the first computer; and
a computer program accessible to the computer for automatically associating the digital image taken by the camera with data indicative of the person.

37. The system of claim 36, further comprising a second computer accessible to the first computer.

38. The system of claim 37, wherein the second computer is accessible to the first computer though the Internet and the second computer is also accessible to the person through the Internet.

39. The system of claim 36, wherein the detector is selected from the group consisting of a barcode scanner, a card reader, an RF antenna, and an OCR reader.

40. The system of claim 36, wherein the first computer is selected from the group consisting of a pen tablet, a microprocessor, and a wireless mobile computer.

41. The system of claim 36, wherein the digital camera is selected from the group consisting of a still camera, a video camera, and a charge-coupled device.

42. The system of claim 36, further comprising a modem, an antenna connected to the modem and a second computer accessible through the modem.

43. The system of claim 36, further comprising an interface card for at least one accessory for the first computer.

44. The system of claim 36, further comprising a signature pad operably connected to the first computer.

45. The system of claim 37, wherein the second computer is selected from the group consisting of a computer associated with a telephone, a personal digital assistant, a wireless handheld device, and a wireless computer.

46. A system for automatically associating a digital image with data indicative of a person, the system comprising:
a first computer having a memory;
a digital camera operably connected to the first computer;
a barcode scanner operably connected to the first computer; and
a computer program residing in the memory of the first computer that automatically associates data from the barcode scanner indicative of the person with the digital image taken by the camera.

47. The system of claim 46, further comprising a second computer accessible through the Internet to the first computer.

48. The system of claim 46, further comprising a modem and an antenna connected to the first computer.

49. The system of claim 46, further comprising a software program for compression residing in the memory of the first computer.

50. The system of claim 47, further comprising a file storing at least one of watermarks, logos, backgrounds, annotations, greetings, and features, the file residing in a memory accessible to the first computer or the second computer.
